(19) United States
(12) Patent Application Publication
(10) Pub. No.: US 2015/0178742 A1
(43) Pub. Date: Jun. 25, 2015

(54) System and Method For The Facilitation of Real-time Customer, Employee and Stakeholder Engagement Through Managed Devices

(71) Applicant: Strum, Inc., Toronto (CA)

(72) Inventors: D. Andrew C. Smith, Toronto (CA); Kevin Kowalewski, Toronto (CA)

(73) Assignee: Strum, Inc., Toronto (CA)

(21) Appl. No.: 14/574,736

(22) Filed: Dec. 18, 2014

Related U.S. Application Data
(60) Provisional application No. 61/918,836, filed on Dec. 20, 2013.

(51) Int. Cl. G06Q 30/02; H04L 29/08

(52) U.S. Cl. CPC G06Q 30/0201; H04L 67/10

(57) ABSTRACT

Systems and methods which facilitate real-time customer, employee and other stakeholder engagement with a business or other organization through managed devices are disclosed. In an aspect, systems and methods are disclosed which enable customers or employees to provide input to a business by responding to content displayed on an electronic device, where the content is controlled by the business or a third party service provider. In an aspect, methods and systems are provided to facilitate localized connectivity channels between a business and its customers for issue resolution.

### CROSS REFERENCE TO RELATED APPLICATION

This application claims the benefit of U.S. Provisional Patent Application No. 61/918,836, filed Dec. 20, 2013, and entitled “System and Method for the Facilitation of Customer and Employee Engagement Through Managed Devices”, the entire contents of which is incorporated herein by reference.

### FIELD OF THE DISCLOSURE

This disclosure is directed to systems and methods for permitting retailers, business enterprises, institutions, governmental entities and others who provide goods and/or services to collect, analyze and action real-time customer, employee and stakeholder opinion (including by third party service providers for the purposes of market research)—including within retail establishments. Additionally, this disclosure is directed to distributed connectivity channels.

### BACKGROUND

The statements in this section merely provide background information related to the present disclosure and may not constitute prior art.

Today, the three fields of (1) customer service, (2) customer experience (a subset of the market research industry more generally), and (3) in-building customer engagement are managed with separate products in separate silos. Customer queries and complaints are generally managed by Customer Service departments—usually in call centers supported by help desk and live chat software. Zendesk is a leader in this space; see http://www.zendesk.com. Regardless of where the incident triggering the customer query or complaint occurred, or how the customer communicated the query or complaint into the organization (e.g., by phone, by email, by social channels like Facebook or Twitter), all customer requests are generally routed to a centralized department for response or resolution. Customers generally do not have an easy path to connect with their local store or service provider electronically, whether to compliment the staff, offer a suggestion or resolve a customer service issue. And enterprises have no easy way of trying to resolve customer issues at the store level first, before they are escalated to the call center.

Whereas customer service is typically focused on responding to and resolving customer requests, customer experience focuses on better understanding, and consequently improving, the end-to-end experience of customers when they interact with an enterprise. Today, customer experience is typically gauged on a post-event small audit basis, generally accomplished by mystery shopping, outbound inquiry (e.g., by phone, by SMS, by email) or receipt-based invitation (i.e., by printing a URL at the bottom of a customer's receipt). Information is collected by survey—often long, time-consuming surveys; sometimes with a reward attached for survey completion. Typically only a small percentage of an enterprise's total customer base provides feedback, and this feedback is typically provided after the events that are the subject of the survey have transpired. Medallia and Empathica (purchased by Mindshare Technologies) are both providers of customer experience management software; see http://www.medallia.com and http://www.empathica.com

The issues impacting the representativeness and timeliness of customer experience data are reflective of problems with current approaches to market research generally. A sample population whose opinion is gauged by time-consuming surveys, or ‘purchased’ through a financial incentive is certainly representative of a narrow group of individuals who are willing to expend material personal time on survey completion (due to interest or financial incentive)—but is it at all representative of the population generally? Just as important, current research techniques, given sample size limitations, have trouble producing granularity across a series of dimensions, e.g., geography and time, meaning that it's often taken for granted that the views expressed by a sample of a national population fairly represent the views of the countless local populations therein (or that local differences aren't relevant). But what if differences in location-based or time-based dimensionality are highly important?

Recently, a few organizations have launched a different approach to feedback intake: making simple feedback devices available on-location and allowing customers to rate their customer experience—either by tapping an emoticon (e.g., a frowning face representing disappointment, a smiling face representing approval), or by tapping a thumbs up or thumbs down icon to an on-screen question. For example, in 2010, Changi Airport in Singapore introduced an Instant Feedback System, placing interactive screens allowing customers to instantly provide satisfaction ratings at key customer touch points throughout the airport. Real-time on-location feedback systems allow enterprises to dramatically increase the volume and breadth of coverage of customer feedback (in the case of Changi Airport, volume of feedback increased by 54 times). Providers of real-time, on-location feedback systems include organizations such as Happy or Not, and Benbria; see www.happy-or-not.com and www.benbria.com. One important feature of customer experience management technology that is not available with current real-time on-location feedback systems is analytical depth, i.e., the ability to drill down and ask customers a range of questions on a range of topics.

While customer experience is primarily concerned with data collection and analysis, today's customer engagement technologies are focused on the distribution of information to inform and entertain their customers. With the help of digital signage software, organizations can centrally create company-specific content and disseminate that content on in-building screens across their footprint. Skala is a leading provider of digital signage software; see http://scala.com. Notably, digital signage software is designed to enable organizations to easily collect, edit and distribute different forms and sources of media over digital devices—potentially including interactive elements. In other words, digital signage software platforms make it easy to convey different sources of information; they are not designed to facilitate ease of information capture and analysis.

Given the foregoing, what is needed are systems and methods which facilitate quick and easy programming and management of on-screen content on a broad array of touch-screen, in-building devices across a range of locations to capture, analyze and report on real-time customer, employee and other stakeholder opinion. Furthermore systems and methods which enable organizations to create and manage local channels of connectivity between customers (or employees or other stakeholders) and their local stores (or departments or offices) for first issue resolution are needed.

The foregoing examples of the related art and limitations related thereto are intended to be illustrative and not exclusive. Other limitations of the related art will become apparent to those of skill in the art upon a reading of the specification and a study of the drawings.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for facilitating customer, student and employee feedback and engagement with a business or other institution through managed devices.

The systems, methods and computer program products of the present disclosure are useful for a variety of institutions including retailers, business entities, universities, government offices and the like. In an aspect, the systems, methods and computer program products of the present disclosure allow institutions to centrally program and manage the content for a broad-based network of in-building touch-screen devices to capture, analyze and action real-time customer, employee and other stakeholder opinion—including the programming and management of a locally distributed customer service channel—enabling organizations to engage and connect with dramatically more customers, resolving customer service issues faster and yielding, interpreting and actioning a data set of stakeholder opinion that is far broader, deeper and more timely than currently available today. In an aspect, the systems, methods and computer program products of the present disclosure facilitates enhanced communication between Businesses and their customers, and to engage in market research on a broadly distributed and highly localized basis. Such facilitation may be by a third party (e.g., an application service provider).

Such in-building devices may provide real-time data sets to operators and are configured to receive content updates immediately and/or outside of business hours. Survey questions may be dynamically presented to customers based on store location, type of department or function within an enterprise, items purchased, demographic information, responses by the customer to previous questions, responses by other shoppers to the same or similar questions, store ratings, employee ratings, and the like. In some aspects, machine learning and other algorithmic approaches are utilized to determine which questions should be presented, or which answer options should be presented. In this manner, systems, methods and computer program products of the present disclosure may gather information about an enterprise's customer base (or, in the case of market research generally, about localized subsets of consumers market-by-market) in a rapid, on-going, and granular manner. Enhanced survey breadth is facilitated because surveys (e.g., micro surveys) may be architected in a many-to-many fashion whereby different customers are asked different questions, enabling a single device to provide multiple different customers with multiple different discrete surveys. Similarly, enhanced survey breadth is facilitated because on-premise devices may be architected according to Managed Device Groups, enabling devices linked to specific functional departments to offer different content than devices linked to other functional departments, as would be the case, for example for Checkout devices versus Customer Service devices. Such systems, methods and computer program products may be utilized to quickly identify at a single-store, neighborhood, or region level or at a department or sub-department level across an organization, interests, likes, and dislikes of the associated stakeholders. For example, different survey questions regarding interest in radio stations may be pushed to deployed devices, enabling the determination, on a neighborhood-by-neighborhood basis, of most popular radio stations. Such information would be useful to an enterprise because it would enable more targeted, effective advertising. Current customers might be more easily reached by advertising on radio stations with the greatest listenership amongst the enterprise's customers on a region-by-region basis (which radio stations may or may not be similar to the most popular radio stations in each of those regions). Similarly, such information would be useful in understanding the differences in consumer product preferences local market-by-local market. The present disclosure may also be used to measure the effectiveness of new product releases, monitor customers' changing tastes, and the like. When a new product is released, questions and advertisements may be pushed to deployed devices, including questions which are designed to measure customer knowledge and excitement about the new product.

For ease of description, a user on the enterprise, organization or government side of the present systems and methods is referred to as “The Business” or “Business” in this summary, the figures, claims and the following Detailed Description. The Business includes a variety of types and sizes of enterprises, including retailers, restaurants, transportation and service providers, business entities, institutions, government offices, and the like. The Business includes all levels and sub-levels of operations, from a local store; a group of local stores associated together into a district; a group of districts or regions of districts associated together, such as operating under the same banner; a global level operation; and all other levels and sub-levels of operations. As used herein, Business includes, but is not limited to, a for-profit operation. Business includes individuals acting on behalf of the entity such as an employee or contractor.

In an aspect, the systems and methods of the present disclosure are cloud-based. In an aspect, the systems and methods of the present disclosure are facility-based, where the systems or portions thereof are physically present in a particular location.

In an aspect, in order to use the systems and methods of the present disclosure, the Business accesses an online administrative portal and creates one or more “Managed Device Groups”—each Managed Device Group able to be programmed to run independently programmed content—and then associates those Managed Device Groups to its various business locations as it wishes. For example, a Business may choose to create three Managed Device Groups—Cash Counter Devices, Exit Kiosk Devices, Floor Pedestal Devices—and assign each of these three Managed Device Groups to some or all of its locations, (e.g., to 50, 500, or other numbers of Business locations). For simplicity of content assignment and reporting, store locations are organized in accordance with the Business's organization hierarchy (e.g., parent/banner/region/district/store) and may also be organized by predefined tags (e.g., mall stores/plaza stores/street-front stores).

The Business then provisions a chosen number of electronic devices for each location and Managed Device Group. Electronic devices may comprise an interactive LCD or LED display for displaying content and receiving user input, for example. For example, a retail Business may have the Cash Counter Devices located at cash registers where customers check out, and the Exit Kiosk Devices at the exit of the facility. In an aspect, the Business accesses the cloud-based account of the system provider through a web-based online administrative portal. The Business can then either select from available existing questions/content, or create content anew. In the latter case, the Business is then provided with a menu of interface types, from which the Business selects a desired type (e.g., “Multiple Choice Interface” or “Yes/No Interface” or “Emoticon Interface”). The Business then edits the selected Interface Type to produce the desired content and saves that type after selection. The Business then tags the content according to functional relevancy to enable functional reporting, e.g., Operations, Marketing, Purchasing, etc. The Business then assigns the content to the appropriate Managed Device Group(s) and the appropriate stores (which can flexibly be done or organization tier, or tag, or by ‘cherry-picking’), then distributes this content either in real-time or on a scheduled basis. Once distributed, the content is then displayed on the designated electronic devices. In an aspect, a third party application service provider may manage all content creation and distribution for certain Businesses, and in addition to asking questions relevant to these Businesses asks questions relevant to all Businesses in the sector, and may ask questions relevant to market research more generally.

In various aspects, the systems and methods of the present disclosure also permit a variety of choices as to which type of Interface or content will appear at each location; for example, the Business may operate in regions with populations using different languages and may wish to produce and display content in a particular language (or choice of languages) for a particular region or even a specific Business location. The systems and methods of the present disclosure are also extremely flexible in permitting the Business to program the frequency, duration and order of the content that is displayed; for example, the Business may have a list of 25 questions it seeks to ask its customers on a continual basis, and another 25 questions it seeks to ask on a seasonal or short-term basis. It may choose to show each individual customer only one of these questions, or two, or five, for example, with different customers presented with different questions. It may choose to have the first question be common to all users, enabling broad-based comparability across devices, locations, and tiers and businesses. It may choose to have the second question be a question of a certain function type and the third question a question relating to another function type (e.g., a universal first question may be structurally always followed by an Operating question as a second question and a Product or Marketing question as a third question). Within their functional question sets, it may choose to have the specific second and third questions shown at random, or it may choose to show some questions with much greater frequency than others. It may choose to show some questions only conditionally upon the selection of a certain answer or answers to other questions.

The system and methods disclosed provide the Business with a mechanism for viewing test screens and accompanying display parameters and, upon approval, publishing the content on the electronic devices in the Managed Device Groups as programmed. The system permits updates of the Managed Device Groups by the Business on a scheduled basis, or on-demand. For greater certainty, the system permits distribution of content to all devices within a Managed Device Group, or to selected screens within the Managed Device Group. Devices can be selected flexibly such that a Business may either quickly choose certain nodes on a reporting hierarchy, e.g., the Atlantic Region, or all Districts in Southern Ontario, or by pre-assigned tag, e.g., all Mall Stores, or by individually selecting one or more specific stores or tiers.

Interface design and interactivity may be configured to maximize user engagement and representativeness. The system thus facilitates graphically rich theming of devices, with Businesses have the ability to choose from different available themes, which may include discrete graphical elements as well as audio and video files, and update screen displays in real-time or on a scheduled basis.

During operation of the system, users, which can be customers or employees, for example, interact with the electronic devices in the Managed Device Groups by tapping pre-programmed answers to on-screen questions or by typing or drawing answers in short responses or in a free flowing format on the electronic device. In an aspect, the user may include additional information, e.g., the user might use the device to take a photo or video of a certain product. These user responses and interactions are sent to the system servers, which consolidates and organizes the responses and interactions. Answers and content can be aggregated, organized and analyzed independently (at the individual node level, or at any level or filter within the organization), or analyzed in conjunction with other data sets, including for example transaction data, location data and weather data. This analysis may include machine learning technology, including for example, to dynamically measure which internal and external elements have the most significant impact on customer experience. Free form comments can be analyzed and organized using natural language processing, for example. The server analyzes the user input and reports information to the Business at pre-determined intervals or on a real-time or near-real-time basis, organized by parameters, including relevance, and in accordance with the organizational hierarchy of the Business by location, by district or any other organizational or functional parameters dictated by the Business. In an aspect, managers of the Business (or a third party service provider) have the ability to rate the usefulness and highlight the relevance of the data and analyzed user input they review, including comments and questions; and the system accordingly adjusts the method of organizing and displaying similar types of information in the future through machine-learning, as understood by a person of ordinary skill in the art upon reading the disclosure herewith. In an aspect, the Business may choose to publish approved comments and other relevant data generated by the system to the devices, for example, at the conclusion of an individual user's activity.

In some aspects, received user responses and interactions are analyzed by the system in real-time. Analysis may classify user responses and alter information next-presented to customers accordingly, including by means of machine learning technology. One purpose of such analysis would be to dynamically adjust the focus of on-screen content to the topics and issues of greatest relevance in a particular store, group of stores, or functional area, but other benefits of such analysis will be obvious to a person skilled in the art. In some aspects, exogenous data are analyzed in real-time, including, for example, data particular to the specific user, including transaction data and location data, and on-screen content is adjusted dynamically to better tailor content to individual users, including by means of machine learning. In some aspects, the system and methods are integrated with the Business's POS. Adjusted content includes both questions to be asked, and answer options to specific questions. In an aspect, the system may select answer options to a specific question from a large pool of answer options, which options may vary depending on the functional or geo-locality of the device to which the question is deployed. For example, the question, “Which of these radio stations do you listen to most often?” may pull from a list representing all radio stations locally available, and so a device in New York may dynamically present different answer options than a device in Toronto, and each time the question is asked, these devices may pull a different sub-set of answer options from a programmed list of locally available radio stations, including by means of machine learning.

In an aspect, all content pertaining to a Business' devices may be created and deployed by a third party. In an aspect, content may also be created and deployed by a Business. Content, including language and theming, may be created centrally, or locally via a distributed management portal or both. Similarly, distribution of content may be entirely centralized, or may permit a level of local control over local content. This facilitates opinion gathering from customers in a hyper-local fashion.

The Business may program the Interface to include a locally distributed customer service channel with electronic devices in Managed Device Groups, whereby a user can request a response from a manager or alternatively to page a manager. The user can opt to receive a response by email, text or directly through an account (e.g., a cloud-based user account) within the systems of the present disclosure; the system then delivers the request to a location manager. In the case when a manager is paged, the system sends a notification directly to the on-duty manager. In the case when a user poses a question through an electronic device, if the location manager can resolve the user's issue, the manager's response is delivered to the customer by the user's chosen response path (for example, email, text or the system account). If the manager cannot resolve the request, the manager triggers an elevation of the user's request to the Business's Customer Service department or otherwise addresses the request.

Regardless of whether a customer requests a contact, Business managers may receive real-time notifications based on customizable rules. Businesses may also opt for managers to receive regular reporting, which may be customized by frequency and composition, including by reference to organizational hierarchy.

In some aspects, distributed devices are in constant or near constant communication with a system server or other portions of the system, thereby enabling dynamic data collection and analysis, content changes, theming changes and the like. Communication may be encrypted, conducted over secure links, or the like.

In some aspects, each device is monitored in real-time 24/7/365 in order to ensure it is functioning properly. A communication is sent to a central server or other monitoring portal on a minute-by-minute basis (or at whatever other frequency optimizes real-time monitoring) to confirm device health status. This communication will trigger an alert in a broad range of circumstances, including if a device loses connectivity, loses access to power, falls below certain defined levels of battery power, falls below certain defined levels of available memory, is showing content that is inconsistent with the content it was directed to display, or the like. In the event of an alert, the system may take actions to resolve the device health issue, which may be accomplished through automated processes, through manual remote programming, or through an alert sent to an onsite employee.

Further features and advantages of the present disclosure, as well as the structure and operations of various aspects of the present disclosure, are described in detail below with reference to the accompanying drawings.

### DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a logic flow diagram illustrating the system and method of the present invention, including its constituent portions, according to an aspect of the present disclosure.

FIG. 2 is a flowchart illustrating an exemplary process for creating and sending content to deployed devices, according to an aspect of the present disclosure.

FIG. 3 is a flowchart illustrating an exemplary process for analyzing data received, according to an aspect of the present disclosure.

FIG. 4 is a flowchart illustrating an exemplary process for a customer to use a device to facilitate an interaction with an employee of the business, according to an aspect of the present disclosure.

FIG. 5 is a flowchart illustrating an exemplary process for dynamically ordering and displaying content on a device in order to collect information from users, according to an aspect of the present disclosure.

FIG. 6 is a flowchart illustrating an exemplary process for monitoring deployed devices, according to an aspect of the present disclosure.

FIG. 7 is a flowchart illustrating an exemplary process for delivering and displaying themes on deployed devices, according to an aspect of the present disclosure.

FIG. 8 is a flowchart illustrating an exemplary process for receiving feedback from customers and delivering actionable electronic messages, according to an aspect of the present disclosure.

FIG. 9 illustrates an interface for receiving information about a user's overall experience, according to aspects of the present disclosure.

FIG. 10 illustrates an interface for receiving information about another aspect of the user's experience, according to aspects of the present disclosure.

FIG. 11 illustrates an interface for receiving information about the user, according to aspects of the present disclosure.

FIG. 12 illustrates an interface for providing communications options to a user, according to aspects of the present disclosure.

FIG. 13 is a block diagram of an exemplary computer system useful for implementing various aspects of the present disclosure.

FIG. 14 is a block diagram of an exemplary system for facilitating user engagement through managed electronic devices, according to an aspect of the present disclosure.

### DETAILED DESCRIPTION

Throughout the following description, specific details are set forth in order to provide a more thorough understanding to persons skilled in the art. However, well-known elements may not be shown or described in detail to avoid unnecessarily obscuring the disclosure. Accordingly, the description and drawings are to be regarded in an illustrative, rather than a restrictive, sense.

This disclosure relates generally to communication and computer system platforms, and particularly to systems, methods and computer program products for facilitating customer and employee and other stakeholder engagement with a business, enterprise or other institution through such systems, methods and computer program products. Additionally, the present disclosure relates to analysis and reporting of information received from customers, employees and other stakeholders to determine, on a real-time basis, customer feedback, opinion and interests on the device, individual store, neighborhood, national, and/or system-wide levels, as well as various functional levels therein. Engagement is facilitated by presenting content pushed to devices within Businesses. Series of queries may be presented, and each series may differ from customer to customer. A series of queries and other content may be programmed to be presented in an initial configuration to a first customer (or a series of queries to a set of initial customers) and subsequently presented, re-ordered, new portions added, or portions excluded based on analysis performed by portions of the system via, for example, machine learning technology. Analysis may also be performed by employees of the associated Business or other human third parties.

In an aspect, provided is a computer implemented method for facilitating user engagement with a Business, the method comprising the steps of: displaying content on an electronic device; receiving, via the electronic device, a user input, the user input being related to the content displayed on the electronic device; providing the user input to a system server; analyzing the user input via the system server, wherein the analyzing is at least in part performed using Business-defined parameters, creating analyzed user input; and providing the analyzed user input to the Business. In an aspect, the method further comprises the steps of: receiving relevance information from the Business related to the analyzed user input; and updating the Business-defined parameters on the system server in response to the relevance information.

In an aspect, the displaying step comprises the steps of: accessing an online administrative portal; creating one or more Managed Device Groups using the online administrative portal, where the Managed Device Groups contain single electronic devices or groups of electronic devices, and the Managed Device Groups designate different aspects of the Business; determining the system rules for each Managed Device Group, said system rules including: the number of content elements to be included within each series of content presented to individual customers, the features to be included within each series (e.g., theming of screens), and the ordering of content elements to be included within each series (e.g., the first element may by rule be exclusively an Operations question, the second element may by rule be either a Marketing or a Purchasing question, the third element may by rule request Customer Commentary, and the fourth element may by rule be a marketing element); creating content for each Managed Device Group using the online administrative portal, said creating comprising the steps of: selecting an interface type; drafting content for a given interface type in a given language(s); where applicable, selecting supporting content for a given interface type, e.g., a video file; classifying the content by functional reporting area (e.g., Operations), assigning the content to one or more Managed Device Groups; flexibly assigning the content to one or more Business locations, selecting the frequency the content will be displayed on each Managed Device Group; and publishing the content on the devices in each Managed Device Group (either in real-time or on a scheduled basis). In an aspect, the Business selects the number and type of electronic devices for each Managed Device Group.

In an aspect, a user is one or more of a customer, a person who enters or otherwise interacts with a Business, or an employee. In separate aspects, the same or different Managed Device Groups and the same or different electronic devices are used to facilitate engagement by customers and employees. In an aspect, the customer device and the employee device are connected, including in real-time. In an aspect, content is one or more queries related to the Business. In an aspect, the user input is selection of a pre-programmed answer appearing on the electronic device or a response input on the electronic device by the user. In an aspect, content includes graphical, audio and or video files.

In an aspect, an electronic device is one or more of a computer; tablet; phone; or touch-sensitive screen. The electronic devices used in any given Business location can be the same or different as the electronic devices used in a different Business location.

In an aspect, there is more than one Managed Device Group, and the electronic devices in one Managed Device Group are positioned at a different functional location in the Business than the electronic devices in another Managed Device Group. In an aspect, the systems and methods disclosed facilitate creation and management of local channels of connectivity between users and their local or global Businesses for issue resolution, among other things. In an aspect, at least one message is sent from a user to the Business; and at least one response is sent from the Business to the user, the response related to the message sent from the user to the Business. In an aspect, a message between the user and the Business is a request to contact a manager.

In an aspect, the content on each electronic device in a Managed Device Group is the same as the content on each electronic device in a different Managed Device Group. In an aspect, the content on each electronic device in a Managed Device Group is different than the content on each electronic device in a different Managed Device Group. This aspect is useful when the Business would like user input on different aspects of the Business.

In an aspect, the content on each electronic device in a Managed Device Group in an individual Business location is the same as the content on each electronic device in the same Managed Device Group in a different Business location or group of locations. In an aspect, the content on each electronic device in a Managed Device Group in an individual Business location or group of locations is different than the content on each electronic device in the same Managed Device Group in a different Business location or group of locations. This aspect is useful when the Business would like user input specific to different regions of the Business.

In the systems and methods disclosed, user input can be made in a number of different ways. For example, the content displayed on an electronic device can be a question and the answers can be “Yes” or “No.” The input can be made by the user selecting the icon for “Yes” or “No” on the electronic device. In an aspect, the content displayed on an electronic device can be an invitation to provide comments and the user input can be made by accessing a keyboard on the electronic device or by recording an audio message using the electronic device. In an aspect, the user input can be a photograph taken by the electronic device. In an aspect, there may be multiple streams of content on the device, with the query on the device referencing graphical, audio or video content specific to that query.

Certain aspects of the disclosed systems and methods are now described in further detail. It is understood that the details are exemplary and provided to aid in understanding the disclosure. It is understood that changes can be made without departing from the spirit and scope of the present disclosure. In an aspect, the content is one question displayed on an electronic device. In an aspect, the question displayed is selected from a set of questions that are pre-determined by the Business. The pre-determined questions can be selected by the Business to vary based on the location of the electronic device (e.g., where the device is within a store, where the store is located), or other factors. Both similar and different content may be displayed to each customer. In an aspect, at an electronic device at the cash counter, each customer may see “How was your experience today?” as the first question. However, each customer may see a similar or different second question. And each customer may see a different or similar third question drawn from a different functional area of the business. For example, after the initial common question, the first customer may see “How quickly did we serve you at cash?” as a second question (Operations) and “Did we have your size?” as a third question (Purchasing). After the initial common question, the second customer may see “Did we say Hi?” as a second question (Operations) and “Which of the following stations do you listen to most?” as a third question (Marketing). After the initial common question, the third customer may see “Did our advisors have the info you were looking for?” as a second question (Operations) and “Did you come in today for an item you saw in our flyer?” as a third question (Marketing). In this way, the Business is able to obtain a consistent measure of hour-by-hour performance through the common first question (How was your experience today?), while at the same time gathering deeper knowledge of its Business with varying follow-up questions—presented in a way that is more customer-friendly (Marketing questions only being asked at the end of a series). At the Automotive Cash Counter, every customer may see the common first question, “How was your experience today?” followed by different or follow-up questions, allowing the Business to target specific insight and feedback relevant to the different areas and functions of its business. At the flyer stand, every customer may exclusively see one question, for example: “Did you receive our flyer this week?” While in the employee lunchroom, all employees may see “How's work today?” followed by a comment screen, “Why?” In an aspect, the methods and systems disclosed allow the Business to tailor both the number of questions viewed by individual customers and frequency of each question at each electronic device and each Managed Device Group, for input collection or other business reasons. In an aspect, the Business may incorporate specific media elements such as photos or videos into specific questions, e.g., in the case of product-related queries.

The systems and methods disclosed allow a Business the ability to tailor the content displayed on an electronic device. For example, a Business may have 25 questions it wants intermittently asked across a Managed Device Group year-round at all locations, and another 25 questions it wants intermittently asked across another Managed Device Group year-round at all locations. Five of these questions may overlap with the 25 questions being asked at the first Managed Device Group. It may also have 25 other questions it wants to ask over the course of the year on a seasonal basis. It may also have numerous questions it wants to ask on a very short-term, promotion-specific or product-release specific basis. It may also have follow-up questions it wants to ask if a customer supplies specified responses to an initial question. The Business may also have questions that are region specific. For example, some product-related or promotion-related questions will only apply to certain geographical regions. The Business may also have questions for which far more answer options exist than can easily be presented on one screen, in which case answer options can be ‘slotted’ into a larger answer option file and be pulled on a rotating basis, including through use of machine learning. Also, the primary language for questions may be English in some regions, Spanish in others and French in still others, depending on the geographical location of the Business. The available language options may be English, French, Mandarin and Hindi in some regions, and just English, or English and Spanish in others. In an aspect, certain questions or answer options can be displayed on electronic devices only in a particular store or location. In an aspect, questions or answer options are presented based on specific previous answer responses. In an aspect, questions or answer options are presented based on specific exogenous data. In an aspect, questions or answer options are presented dynamically based on location-specific or Managed Device Group-specific prior response patterns or other data patterns, in order to facilitate enhanced relevance, precision, engagement and the like. Such dynamic ordering and presentation may be done by on-site or off-site software modules and be based on analysis of internal or external sources of data including, but not limited to: received ratings or responses from customers; previous answers; data specific to a location, Managed Device Group or tier; purchase information; prior transaction and demographic information; foot traffic data; sale information; advertising information; upcoming holidays; weather; weather forecasts; and future product releases.

The content displayed in the systems and methods disclosed herein can have icons, images, animations, video files, audio files and other graphical elements and the like that change, for example emoticons made from a pumpkin shape can be used for Halloween, emoticons made from a snowman can be used for Christmas, emoticons made from a heart shape can be used for Valentine's Day, and so forth. Similarly, animations, audio elements, video elements and other graphical elements may be changed, including to emphasis certain seasons or special events. For example, a background video may present falling snowflakes in winter versus an occasional butterfly in summer. The animations surrounding a pressed button or screen transitions or language option transitions may be changed. All of these changes may attract users and increase user engagement with the electronic device. In an aspect, the systems and methods disclosed facilitate user engagement by receiving and analyzing user input on temporary or seasonal questions. In an aspect, the system is configured to schedule, deliver and apply such graphical and/or audible changes by sending theme files or a group of files to deployed devices. Themes may be created which change the overall look and feel of the device interface, change icons, add motifs (e.g., Christmas motif, Halloween motif, football motif), alter sounds, change animations, and the like. Devices may include a default theme which is utilized in the absence of an active overriding theme. Themes may include instructions on when they will be active, such as a period of time. Devices may include modules which ensure the integrity of the received theme (e.g., running a checksum on the file) and successful application of the theme.

In an aspect, the user is an employee. In an aspect, the systems and methods are used for facilitating engagement with the Business from an employee. In an aspect, the systems and methods disclosed receive and analyze user input from employees. In an aspect, an electronic device or Managed Device Group can be placed in locations where employees can provide user input, for example a break room or other convenient location. In this aspect, when the user is an employee, the content can be organized in a different manner than when the user is a customer. In an aspect, when the user is an employee, the electronic device can display a first screen that organizes the employee feedback by topics such as Product, Store Environment, Service, Promotions or Other, and then a second screen where the employee enters the input on the selected topic. In an aspect, the employee feedback can be associated to specific employees. In an aspect, the Business can send a response to the employee user, for example an answer to an employee question. In an aspect, managers can record feedback pertaining to specific employees and associate that to a specific employee. In an aspect, all feedback related to an employee is recorded and organized by employee.

In an aspect, the electronic devices are tablet computers which are mounted or physically attached to various locations in a Business, as will be understood by one of ordinary skill in the art after reading the disclosure herewith. In an aspect, an electronic device is a mobile phone which is programmed as the user enters or exits a Business location, for example.

In an aspect, the electronic devices and content are centrally managed. The electronic devices can either be managed by the Business, or by a service provider through a managed services agreement, for example. In an aspect, the content is centrally managed by a designated individual or group at the Business. This individual or group may manage the interfaces and may grant access to change content to individuals or groups at the central (e.g., to the Market Research team), regional (e.g., to a specific Banner), or store-based level. For example, a retailer may have certain designated “lab” stores where it tests new store formats, products, or other features. In this aspect, the Business can grant the lab store location manager the rights to add content soliciting user input about specific items relating to this lab store. In another aspect, each franchisee principal in a franchised Business may have the ability to add, edit and remove specific types of content separately from another franchisee principal in the Business.

In an aspect, the systems and methods disclosed can be accessed using various programming options, such as apps or web widgets or accessing a browser-based web page. In an aspect, a stand-alone native Android app can be used. In an aspect, there is a different app for each Business. In an aspect, a central web-based portal is used for content management and user input reporting and analytics. These aspects and the uses thereof are well known by a person having ordinary skill in the relevant art(s) upon a reading of the disclosure herein.

In an aspect, in the systems and methods disclosed, the electronic device displaying content is designed to immediately communicate its purpose; be highly engaging; be quick and easy to use; and collect as much relevant user input as possible. In an aspect, in the systems and methods disclosed, the electronic device displaying content has a user interface that is not static. In an aspect, one or more of the following example interfaces is displayed on the electronic device. The interfaces, questions, question options or other content can be modified by the Business to capture desired user input, as will be understood by a person of ordinary skill in the relevant art(s) upon a reading of the disclosure herein.

Interface A: “Emoticon” Interface: For example, “How Was Your Experience Today?” Response Buttons: For example, Terrible, Poor, OK, Good, Awesome.

Interface B: “Yes/No Question” Interface: For example, “Did We Have What You Were Looking For?” Response Buttons: For example: No, Kinda, Yes.

Interface C: “Multiple Choice Question” Interface: For example, “Favorite Radio Station?” Response Buttons: For example: A. 92.5, B. 99.9, C. 102.1, D. 104.5, E. 107.1, F. AM680.

Interface D: “Multiple Choice Graphic” Interface: For example, “Favorite Hoodie?” Response Options: For example: photographic or video representations of several available hoodie options.

In an aspect, after the user has provided input by pressing an answer in response to content via an Interface Question, the electronic device displays a follow-up screen that says “Thank You!” and provides the following example options:

Add a Comment

Page a Manager

Have a Manager Contact You.

If the user taps “Add a Comment” the electronic device screen changes to a screen that says, for example “Please let us know what's on your mind!” and includes a keyboard. In an aspect, this interface includes a button which is used to “send” the user input. In an aspect, once the user presses the “send” button, the content on the electronic device changes to say, for example “Thanks for Taking the Time to Share Your Thoughts. We've Sent Your Feedback Directly to the Location Manager”. The screen then disappears and reverts to the introductory screen. If the user taps “Page a Manager” they are taken to a screen that says “Thanks! A Manager will be with You Soon.” The screen then disappears and reverts to the introductory screen. If the user taps “Have a Manager Contact You” they are taken to a screen that says “Thanks! Please Enter Your Email Here and a Manager will Contract You within the Next X Hours.” The screen then disappears and reverts to the introductory screen.

In an aspect, the confirmatory “Thanks” screen includes information relevant to the customer, e.g., approved comments made by other customers that the Business is now actioning. In an aspect, the content pipeline contains a product-related or other marketing element following the “Thanks” screen which is displayed prior to reverting to the introductory screen.

As will be apparent to one of ordinary skill in the relevant art upon reading the disclosure herein, there are many types of content that can be displayed on the electronic device. In an aspect, the content displayed is used to provide information about products or services. In an aspect, the content displayed is used to ask a question about the Business or about a product or service. Some non-limiting examples of content are shown below for illustration purposes:
Content: Did we have what you were looking for? Answer choices: Yes//No
Content: Favorite product you saw today?
Content: Product you'd most like us to introduce?
Content: Did you watch last night's Leafs v. Habs game?
Content: Did we give you a great smile? Answer choices: Yes//No
Content: Which of these products would you most like us to introduce: Answer choices: A product/B product/C product/D product
Content: Were we able to answer all of your questions? Answer choices: Yes//No

In an aspect, an electronic device is located at the exit of a Business. In an aspect, this electronic device can facilitate user engagement with a Business by displaying content including one or more of the following:
Ability to quickly rate the Business by displaying content such as “How did we do today?” and answer choices Terrible, Poor, Okay, Good, Awesome, each shown by a emoticon or other interface;
Ability to provide comments on categorizes such as:
Service
Product
Pricing & Promotions
Store Environment
Ability to tag an employee;
Ability to add a photo or audio comment; and other content as will be readily determined by one or ordinary skill in the relevant art(s) upon reading the disclosure herein.

In an aspect, once the user has provided the user input, the electronic device displays a thank you screen, which may optionally include features such as the ability to input an email address or other contact information.

In an aspect, the Business employee can be provided with the user input from a customer in-real time by means of a notification or alert. In an aspect, the Business employee can determine the threshold for notification, e.g., more than one Terrible or Poor review within a 60 minute period. This aspect can be used to improve the customer experience before, for example, a poor review on an online rating service is made.

In an aspect, the systems and methods disclosed facilitate user engagement with a Business by analyzing user input and providing the analyzed user input to the Business. In an aspect, the analyzed user input is organized in any useful manner, as will be understood by one of ordinary skill in the art after reading the disclosure herewith. In an aspect, the analyzed user input is provided to the Business in the form of a report containing items such as one or more of: Customer Pulse (graphical representation of the hour-by-hour or day-by-day or week-by-week average customer experience (“CE”) over a selected range of time) and number of user inputs for each point in time; the average CE Score for the chosen date range plus the total number of user inputs for that date range; the Distribution of user inputs for CE Score for the chosen data range; comparative analysis of CE Scores and other inputs by Managed Device Group and across locations, districts, regions and banners; identification of best and worst periods of day and week by location and across location for varying periods of time; analysis of correlation between CE Score and other exogenous data including transaction data, loyalty data, demographic data and weather related data; analysis of causation of low and high CE Scores by reference to follow-up questions; patterns in Operations, Marketing and Purchasing questions by time and by region; analysis of customer commentary to reveal trends, including trends regarding positive employee performance, product availability, customer demand, customer tastes, etc. The form and organization of analyzed user input can be one of a number of pre-determined formats, or the analyzed user input can take a format that is tailored to a Business. These aspects and the use thereof are well known to a person of ordinary skill in the art upon a reading of the disclosure herein.

In an aspect, the analyzed user input is used to allow the Business to provide feedback to employees about their performance on a more frequent basis than a semi-annual review, for example. This allows employee education to occur when the employee-user interaction is still fresh in the mind of the employee, potentially allowing for greater employee and user satisfaction. In an aspect, the analyzed user input can be used by the Business to affect scheduling of employees. For example, if user input indicates the customers have to wait to check-out or for employee assistance during a particular time frame during the day, additional employees can be scheduled to work during that particular time frame. In an aspect, the analyzed user input can be used to affect the product stocking in a Business. For example, if user input indicates a Business or location is out of a certain item, additional stock of that item can be ordered. In an aspect, because the analyzed user input can be delivered to the business frequently, the product stock can be ordered more quickly than if the user input was received by the business in a different manner. In an aspect, the analyzed user data can be used to provide data-driven marketing effectiveness analysis, where the particular effectiveness of different types of media can be tested at a highly granular level. There are many uses of the analyzed user data that are not described here that will be appreciated by a person of ordinary skill in the art upon a reading of the disclosure herein. These uses are intended to be included in the disclosure herewith.

In aspects, the user input is provided to the system server on a real-time basis. This user input is collected at the system server and analyzed in real-time, providing the business a current view on key trends, including temporal trends (e.g., hour-by-hour changes in operating performance or customer demand), region-based trends, functional or department-specific trends, and the like. By asking many questions across many customers across many stores, and by correlating results with other data, Businesses can better identify and attach causality for performance and other issues, as well as identify opportunities and how they may best be actioned. For example, in the case of a new product launch, the content displayed on the electronic devices could include questions like “Were you aware that we've launched ______?” By analyzing responses in real-time or near real-time, the Business can test the regional effectiveness of specific elements of its marketing plan and its merchandising.

In an aspect, the systems and methods disclosed have the flexibility to tailor the analyzing of user input to any desired level. For example, in an aspect, user input is associated to a particular electronic device at a specific location, such as cash-register 1 at Store X. The user input can then be aggregated to the regional, banner and global levels, as specified by the Business according to Business-defined parameters.

Every organization hierarchy is different. However, frequently there are more than five levels to a Business architecture, which may include: global, banner, nation, region, district, store, function, device-level. The systems and methods disclosed herein allow a global Business enterprise to receive analyzed user input at any level or group of levels. For example, a particular Business can own more than one banner store group. In this aspect, the parent Business can have average customer satisfaction analyzed and reported at the cashier-level (i.e., the device-level), the functional-level (i.e., for a department manager), the store-level, the district-level, the regional-level, the national level, the banner level and enterprise-wide level, for example. In addition, the particular Business may wish to have user input treated differently in different locations, such as in different countries, different parts of one country, different states, and even different neighborhoods. The particular Business may also wish to have user input treated differently for different types of stores (e.g., mall stores, plaza stores, street-facing stores) and for different functions (e.g., customer service, automotive). The Business can also receive user input on the banner level (Clothing Brand A store versus Clothing Brand B store) and enterprise-wide level. In an example, a Business with 200 stores in one banner has three sister banners representing another 600 stores. In an aspect, using the systems and methods disclosed, the Business has the ability to tailor the content on the electronic devices at the banner level, as well as the regional, store-level and device-levels. The collection and analysis of user input at each of these levels allows the Business to receive user input and feedback in a timely, representative, granular, organized way to allow Businesses to make timely decisions using the user input.

In an aspect, the systems and methods disclosed facilitate user engagement by receiving and analyzing user input according to topics such as core customer experience, operations, marketing, purchasing, employee data, comments. In an aspect, core customer experience rating includes user input to content such as “How Was Your Experience Today?” In an aspect, comments include user input to content such as “What Would You like Us to know?” In an aspect, operations data includes user input to content such as “How Quickly Did We Serve You at Cash?” The user input can be analyzed using parameters such as location of the electronic device in a business, and business-to-business comparisons.

In an aspect, the Business can receive user input about a user's interests on a store or neighborhood level in near real time by displaying content such as questions and other materials, and having the ability to change the displayed content at will and remotely. For example, user input can indicate users in one neighborhood like the band Creed, based on user input at a local store; where users in another neighborhood like the band Green Day, based on user input at another local store. Product preferences of users can be analyzed in a similar manner. This user input can be used by the Business or collected for third parties. For example, user input can be used by people or other businesses offering products within the store, people marketing to users who shop at a particular store, and for other uses.

In an aspect, disclosed is a system for facilitating user engagement, the system comprising: a core server having a processor and connected to a data storage for administration of one or more Managed Device Groups, a processor of the core server is configured to: display content on an electronic device; receive, via the electronic device, a user input, the user input being related to the content displayed on the electronic device; provide the user input to a system server; analyze the user input via the system server, wherein the input is analyzed at least in part using Business-defined parameters to create analyzed user input; and provide the analyzed user input to the Business. In an aspect, the processor of the core server is further configured to: access an online administrative portal; receive a request to create one or more Managed Device Groups using the online administrative portal, where the Managed Device Groups are single electronic devices or groups of electronic devices, and the Managed Device Groups designate different aspects of the Business; receive a request to establish system rules for each Managed Device Group, said request to establish system rules comprising requests to: select the number of content elements to be included within each series of content presented to individual customers, select the features to be included within each series, and select the ordering of content elements (by function or type) to be included within each series; receive a request to create content for each Managed Device Group using the online administrative portal, said request to create content comprising requests to: select an interface type; draft content for a given interface type in a given primary and, where applicable, optional language(s); where applicable, selecting question-specific supporting content for a given interface type, e.g., a video file; classifying the content by functional reporting area (e.g., Operations); assign the content to a Managed Device Group; flexibly assigning the content to one or more Business locations; select the frequency the content is displayed on each Managed Device Group; publish the content on the devices in each Managed Device Group (either in real-time or on a scheduled basis). In an aspect, the processor of the core server is further configured to: send at least one message from a user to the Business; send at least one response from the Business to the user, the response related to the message sent from the user to the Business.

In an aspect, disclosed is one or more computer storage media having stored thereon multiple instructions that facilitate user engagement by, when executed by one or more processors of a computing device, causing the one or more processors to: display content on an electronic device; receive, via the electronic device, a user input, the user input being related to the content displayed on the electronic device; provide the user input to a system server; analyze the user input at least in part using Business-defined parameters to create analyzed user input; provide the analyzed user input to the Business. In an aspect, the multiple instructions further cause one or more processors to access an online administrative portal to: receive a request to create one or more Managed Device Groups using the online administrative portal, where the Managed Device Groups contain single electronic devices or groups of electronic devices, and the Managed Device Groups designate different aspects of the Business; receive a request to establish system rules for each Managed Device Group, said request to establish system rules comprising requests to: select the number of content elements to be included within each series of content presented to individual customers, select the features to be included within each series, and select the functional ordering of content elements by function or by type to be included within each series; receive a request to create content for each electronic device in the Managed Device Groups using the online administrative portal, said request to create content comprising requests to: select an interface type; draft content for a given interface type in a given primary, and where applicable, optional language(s); where applicable, selecting question-specific supporting content for a given interface type, e.g., a video file; classifying the content by functional reporting area (e.g., Operations); assign the content to a Managed Device Group; flexibly assigning the content to one or more Business locations; assign the content to a Managed Device Group; select the frequency the content is displayed on each Managed Device Group; publish the content on the devices in each Managed Device Group.

In an aspect, the multiple instructions further cause one or more processors to send at least one message from a user to the Business; send at least one response from the Business to the user, the response related to the message sent from the user to the Business.

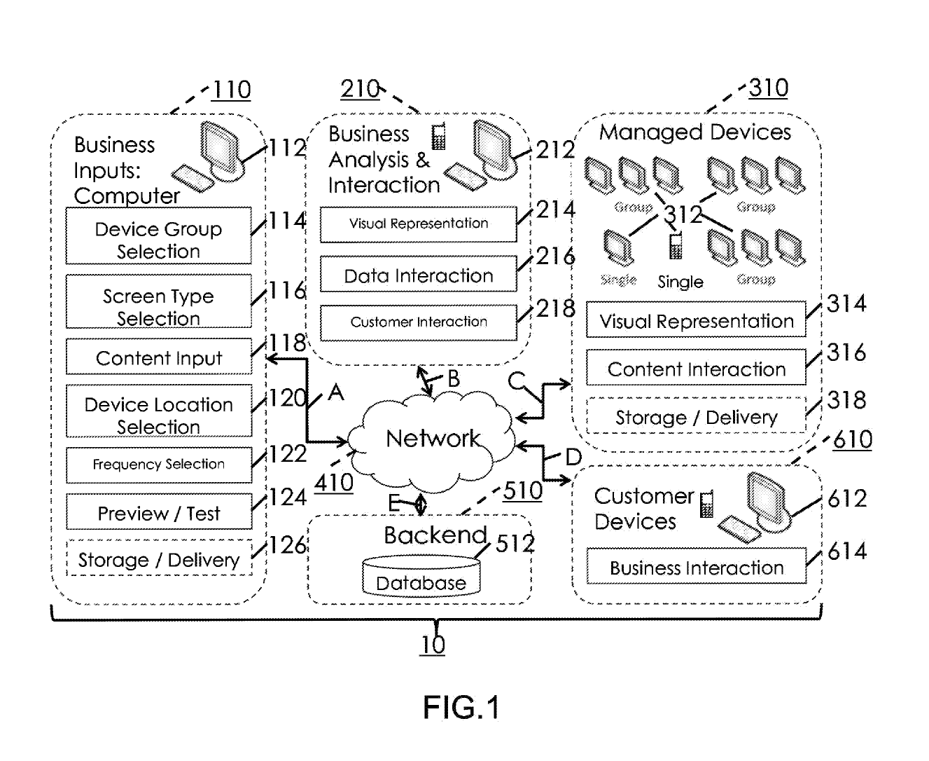

The details of the present disclosure will now be described with reference to FIGS. 1-10.

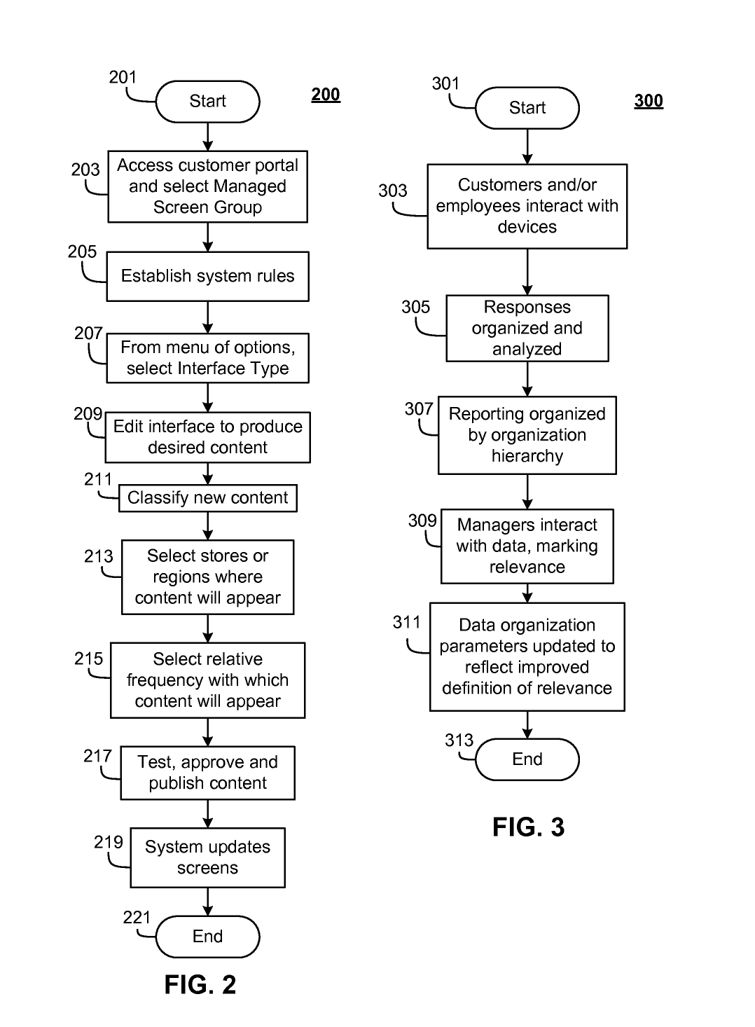

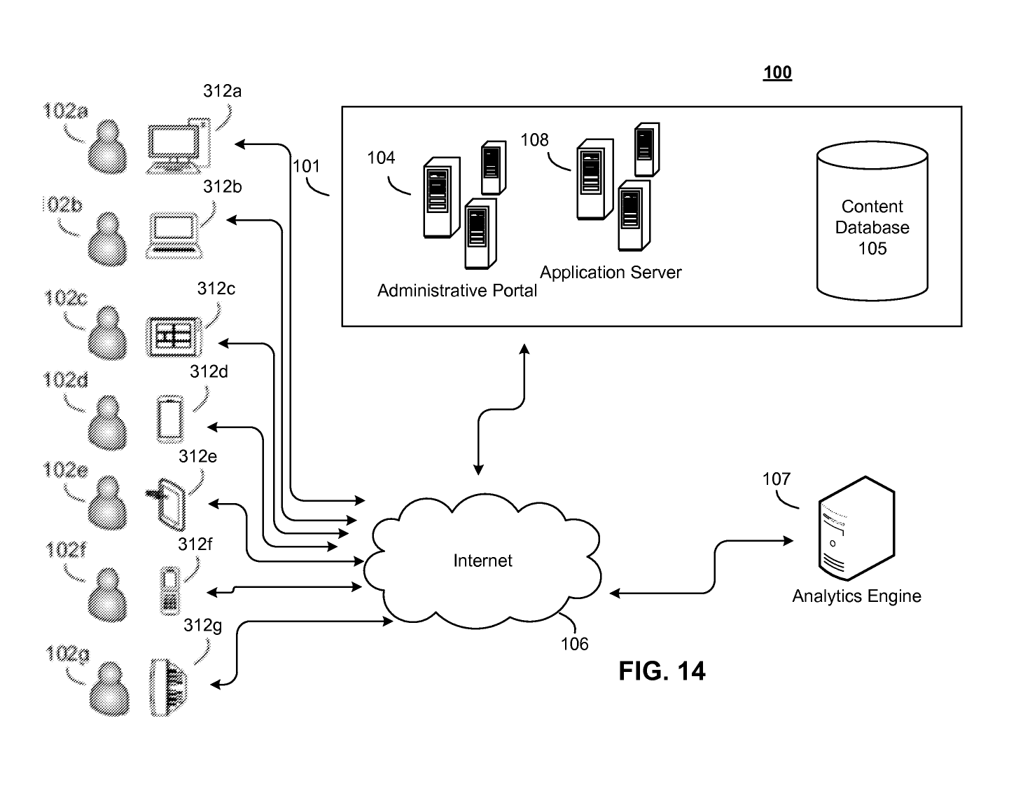

First noting FIG. 1, the overall system 10 includes the following sections: The Business input computer section 110; The Business analysis and interaction section 210; the Managed Devices section 310; the network 410; the back end database section 510; and the customer devices section 610. The system is interconnected with interactive data transmission links A, B, C, D and E. As illustrated in FIG. 1, each of the sections includes constituent parts the function of which is identified by the reference numeral associated with each element. For example, business input computer section 110 includes a computer 112, a device group selection capability 114, a screen type selection 116, a content input 118, device location selection 120, frequency selection 122, preview/test 124, and storage/delivery 126. Business analysis & Interaction section 210 includes computer 212, visual representation 214, data interaction 216, and customer interaction 218. Managed device section 310 includes Managed Devices with multiple and single electronic devices 312, visual representation 314, content interaction 316 and storage/delivery 318. Backend section 510 includes database 512. Customer devices section 610 includes devices 612 and business interaction 614. The sections are connected to network 410 using interactive data transmission links. These various functions and other functions and processes are described in more detail with references to FIGS. 2-8. As will be apparent to those skilled in the relevant art(s) after reading the description herein, additional processes and functions may be carried out. It will be appreciated by those skilled in the art after reading the description herein that the overall system configuration shown as system 10 in FIG. 1 can be modified in a variety of ways without departing from the spirit and scope of this disclosure. FIG. 14, described below, depicts one such configuration.

FIGS. 2, 3 and 4 illustrate processes related to portions of the system 10 of FIG. 1.

Now referring to FIG. 2, a flowchart illustrating an exemplary process 200 for creating and sending content to deployed devices, according to an aspect of the present disclosure, is shown.

Process 200, which may execute within system 10 and facilitate creating and publishing of one or more questions or other content (e.g., set of questions, follow up questions) for presentation via device 312, begins at step 201 with control passing immediately to step 203. Process 200 facilitates the creation of new content with little or no programming experience, enabling a broader spectrum of users and more rapid deployment of questions and other content, thereby facilitating real-time customer engagement analysis.

At step 203, an employee or other representative of a Business accesses a management portal and selects a managed screen group. In an aspect, the Business accesses its account through a web-based portal and selects a Managed Screen Group, e.g., “Cash Counter Screens”, for editing. The Business may have only one Managed Screen Group or several Managed Screen Groups, e.g., Cash Counter Screens, Comment Kiosk Screens, Display Counter Screens, On-Location or Connected Customer or Employee-owned Screens.

At step 205, the Business establishes system rules for the Managed Device Group.

At step 207, an interface type is selected. Interface types may include a multiple choice interface, a yes/no interface, an emoticon interface, or the like.

At step 209, a basic template of the selected interface type is presented and edited. The Business may edit the selected Interface Type to produce the desired customer content, including selection of primary and optional languages. For example, after selecting the yes/no question interface type, the following query may be input into and saved: “Did we have everything you were looking for today?” In some cases, a question will have more answer options than can be presented in one screen. In this case, multiple answer options may be entered that will be rotated into the question based on system rules, including by means of machine-learning. In some cases, an interface type will require external content, e.g., photographs or videos, in which case these will be uploaded to the system server at this step. Note that the system has many ‘standard’ questions that are available to the Business; thus the Business may opt to bypass steps 207 and 209 by choosing a pre-created question.

At step 211, the new content is classified by function in order to enable functional reporting, amongst other things, e.g., Operations, Marketing, Purchasing.

At step 213, where the new created content will be displayed is chosen. In an aspect, the default display location is all locations. The Business may select regions, specific stores, areas and the like. For example, the Business may operate in regions with different languages and may wish to produce content in a particular language for a particular region. For example, regional variances may be relevant to answer options, such that the same question may require different answer options in different regions.

At step 215, the relative frequency with which the content appears is provided. For example, the Business may have assigned fifty different questions. Additionally, some questions may have more answers than can be shown in a single screen, such that answer options must be rotated into the question, including by means of machine learning. By default, all questions may be shown with equal frequency. The Business may revise this to over- or under-index particular pieces of content. In some aspects, this is an initial frequency only. Analytics engines may alter the ordering or frequency a question is presented, based on external and internal factors.

At step 217, the Business tests, approves and publishes (in real-time or on a scheduled-basis) the newly created content. The Business may view test screens and the accompanying display parameters, approve the information presented and publish the content for pushing to deployed devices.

At step 219, deployed devices receive the newly created content, according to inputs provided during the creation process and present the content to customers.

Process 200 then terminates at step 221.

Now referring to FIG. 3, a flowchart illustrating an exemplary process 300 for analyzing data received via devices 312, according to an aspect of the present disclosure, is shown.

Process 300, which may execute within system 10 and facilitate determining the relevance of data received from, for example, customers interacting with devices 312, begins at step 301 with control passing immediately to step 303. Process 300 may be conducted exclusively by software modules within system 10, thereby identifying important data without the assistance of human users, or it may be carried out by a combination of machine learning modules and human users. In some aspects, an analytics module and/or other modules of system 10 analyze data received and adjust content display ordering, choose follow-on questions, and the like.

At step 303, individuals such as customers or employees interact with devices 312 by, for example, answering presented questions about their experiences. For example, customers may interact with device 312 by tapping pre-programmed answers to on-screen questions, or by typing or drawing answers in short response or free flowing format.

At step 305, the responses are organized and analyzed via module 210. Organization and analytics may also occur on device 312 that received the input, on another device 312, or distributed across some or all devices 312. Yes/No and multiple choice answers are organized and collated. Free form comments are analyzed and organized using natural language processing. Analysis may include identification of specific trends and recommended actions based on those trends (e.g., order more of a specific product, schedule more cashiers during evening hours).

At step 307, system 10 provides reporting of the information received, trends identified, recommendations and the like. System 10 reports information, organized by parameters, including relevance. Reporting is organized in accordance with business's organizational hierarchy, e.g., by location, by district, by banner. Reporting may also be organized by custom filters, e.g., type of store, items purchased, basket size, loyalty and the like.

At step 309, an optional step, the Business (via for example a manager) may interact with the presented data and assign relevance, accept or reject recommendations, and the like.

At step 311, data organization parameters are updated to reflect the analysis performed by system 10 and/or the Business. Changes are dynamically reflected in Business' data organization parameters through machine learning. Among other things, data organization reflects the improved definition of relevance. Content presentation may be altered based on updates in this step, facilitating more precise data collection from customers.

Process 300 then terminates at step 313.

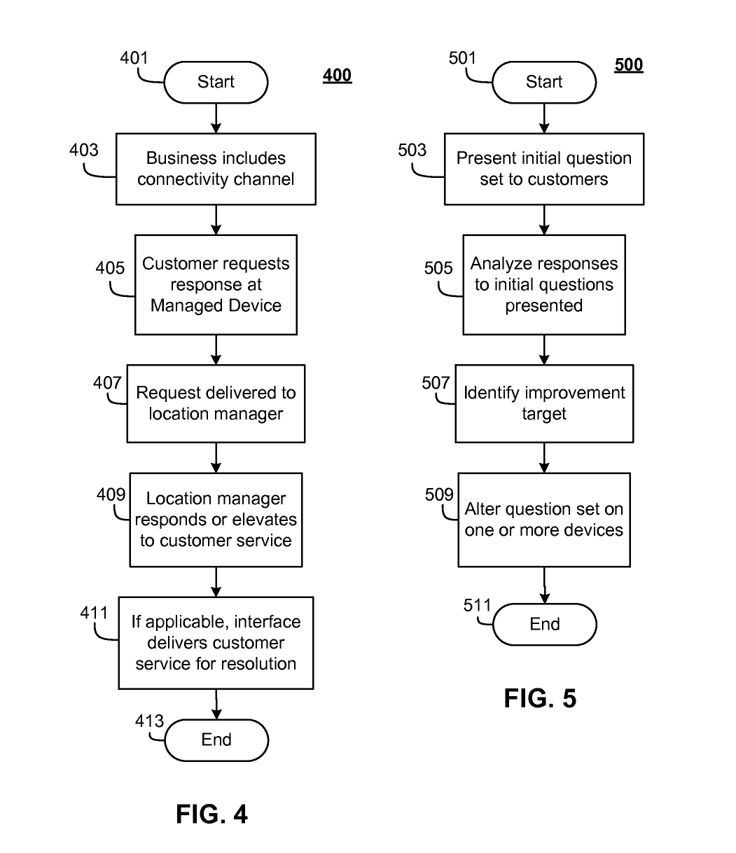

Now referring to FIG. 4, a flowchart illustrating an exemplary process 400 for a customer to use a device 312 to facilitate an interaction with an employee of the business, according to an aspect of the present disclosure, is shown.

Process 400, which may execute within system 10 and facilitate interaction with an employee of the Business and/or receiving a computer generated solution via device 312, begins at step 401 with control passing immediately to step 403. FIG. 4 is an example of using the systems and methods disclosed for distributed connectivity channels.

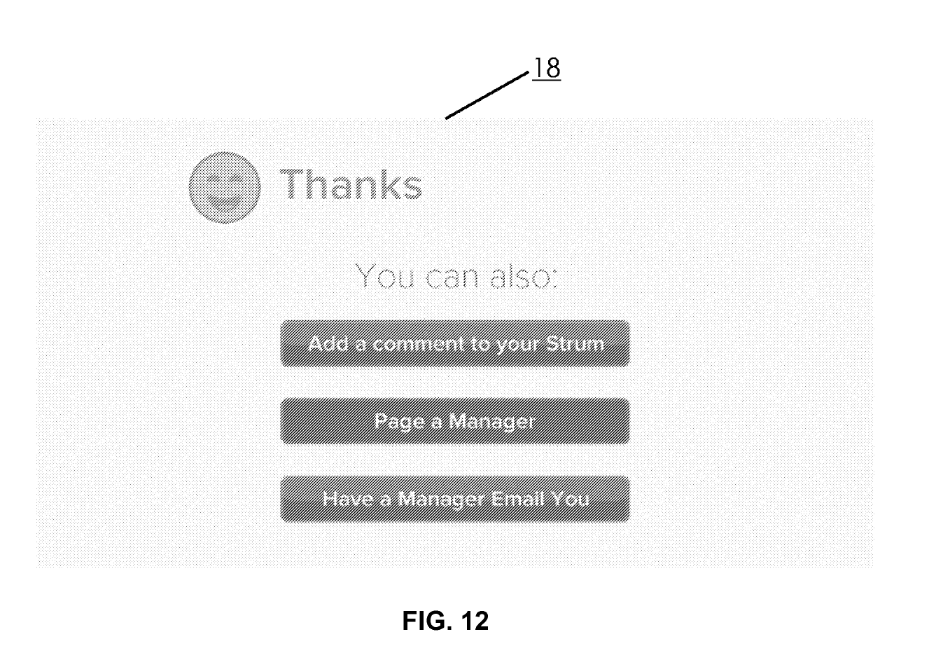

At step 403, a connectivity option is included in the content displayed. FIG. 12 is an exemplary connectivity page. Such connectivity content provides the customer with a variety of options to request a response from an employee (e.g., page a manager, have a manager contact me).

At step 405, a customer interacting with device 312 requests a response from an employee of the Business associated with device 312. In various aspects, the customer can page a manager, opt to receive response by email, text or directly through the Business' account in system 10.

At step 407, the request received at step 405 is sent to the location manager for the location device 312 is deployed. For example, in the case of a page, a notification directly to the on-duty manager. In various aspects, location managers can manage how they are notified of customer requests.

At step 409, the location manager attempts to address the concern. If the manager is able to address the concern, process 400 proceeds to step 413 and terminates. The location manager may elevate the request to customer service or another portion of the Business.

At step 411, the request is delivered to customer service for resolution. In some aspects, system 10 may suggest or present possible resolutions to the customer.

Process 400 then terminates at step 413.

Referring now to FIG. 5, a flowchart illustrating an exemplary process 500 for dynamically ordering and displaying content on a device in order to collect information from users, according to an aspect of the present disclosure, is shown. Systems, methods and computer program products of the present disclosure may present content such as questions to customers within a store or other Business location and dynamically, based on external or internal data, change what questions are presented on an individual or group basis. That is, a Business may target insight and feedback by presenting questions to users dynamically based on known internal and external data. Dynamically adjusting question presentation (or selection of specific answer options) may facilitate greater engagement, may increase information relevancy (by focusing on a known issue), may increase information precision, and the like. As an example, an initial list of questions and options are statically defined for display on device 312 where the displayed options are from a statically defined pool. The initial list of questions and order along with options displayed are considered a training set for the machine learning technology contained in system 10 and/or analytics engine 107 at which point questions will be re-ordered, included or excluded and options will be re-ordered, included or excluded. In this manner, system 10 may alter content without direction from a manager or administrator. Internal or external sources of data available to the algorithm(s) can be realtime or historical. Internal sources can be any of but not limited to: customer ratings; responses by the customer to previous questions; responses by other shoppers to the same or similar questions; data specific to the device, data specific to the device group; and data specific to the Business Tier. External sources can be any of but not limited to: purchase information such as item, sku or price; loyalty information such as historical purchase activity; loyalty information such as demographics; weather conditions such as temperature, cloud cover or humidity; weather forecasting; foot traffic data; and sale or advertising information. The algorithm and determination may be performed by a computer designated as a server, a mobile or modular computer that is customer facing, or a combination thereof. This alteration may be done periodically or continuously. Changes may be implemented across one or many locations and/or devices 312, thereby enabling low traffic devices 312 to utilize questions and ordering developed from high traffic devices 312. Changes may be implemented at the entire system level.

Process 500, which may execute within system 10 and facilitate altering screen content based on external and internal data in order to, among other things, improve answer rate, improve answer and answer option relevance, improve answer and answer option specificity, and/or build a better understanding of customers that visit the location, begins at step 501 with control passing immediately to step 503.

At step 503, an initial question set and order is presented via one or more devices 312. For example, a question set and order developed by an administrator using process 200 may be presented to customers via a device 312 at each checkout line (e.g., the checkout kiosk, a device in front of a cashier) over several days at a single location. As another example, an initial question set and order is presented over all devices 312 at multiple stores at least once.

At step 505, responses are received related to the initial question set and order and analyzed. Analysis is performed by an analytics engine or other portion of system 10. Analysis may be performed in a manner similar to process 300. Analysis may identify questions which customers are most likely to respond to, areas of customer interest, areas where more information from the customer is desired, and the like.

At step 507, an improvement target is identified. The improvement target may be supplied by users or identified by system 10. For example, improving answer rate may by the improvement target. Learning more about the customer complaints may be the improvement target. Learning more about what the customer liked about the location may be the improvement target.

At step 509, the questions and/or order in which they are presented is altered based on the improvement target. For example, where improving answer rate is the improvement target, system 10 may reorder the questions presented to present questions that have a high answer rate first. Additional questions may be created having a similar structure to questions that have a high answer rate (e.g., introduce more yes/no style questions).

Process 500 then terminates at step 511.

Process 500 may operate on per device 312 basis, a location basis, a region basis, or the like. Process 500 may be repeated at intervals, after each customer interaction, or another frequency. Question sets, follow up questions, and ordering may be pushed selectively to devices 312 as needed.

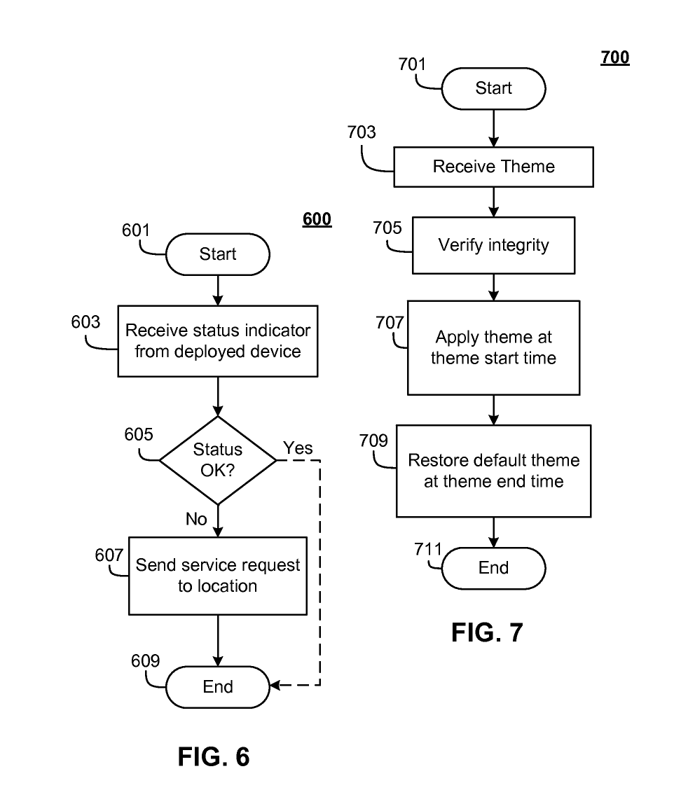

Referring now to FIG. 6, a flowchart illustrating an exemplary process 600 for monitoring deployed devices 312, according to an aspect of the present disclosure, is shown. Devices 312 are connected to controlling and management portions of system 10 in order to receive updates and provide responses for analysis. Such a connection may also be utilized to ensure that deployed devices 312 are in proper working order by having devices 312 send status indicators at periodic intervals and/or when issues arise. System 10 may also send periodic status queries, which devices 312 respond to.

Process 600, which may execute within system 10 and monitor devices 312 connected via network 410 to modules 110 and 210, begins at step 601 with control passing immediately to step 603.

At step 603, a central server or monitoring module receives a status indicator from deployed device 312. The status indicator can be any of the following: OK; unreachable; out of memory; out of disk space; crashing or have crashed; external software failure or misconfiguration; unplugged; or low battery. Other statuses apparent to those skilled in the relevant art(s) after reading the description herein may be sent. No status may be received, indicating that device 312 is not operating or unreachable. Status indicators may also be received in response to successful or unsuccessful loading of an update pushed to device 312. Status indicators may be monitored. For example, statuses may be displayed via a grid or other visual layout with color, text and/or icons indicating each device 312 status. In some aspects, a screen capture module within device 312 periodically, continuously, or on an on-demand basis captures a screenshot of device 312 for transmission as a status indicator. The screen capture module captures the screenshot, compresses the image, and sends the compressed screenshot to the central server or monitoring module. The compressed screenshot is then analyzed using a screen capture analysis module in order to determine if device 312 is displaying the desired content, is displaying any undesirable images (e.g., a system update dialog box, an error message), and the like. In this manner, device status 312 may be determined via screenshot analysis.

At step 605, if the status indicator received is OK, process 600 proceeds to step 609 and terminates. If the status indicator is not OK, step 607 executes and automatic and manual servicing is initiated according to servicing rules and commands received from monitoring personnel. Notification messages may be sent to on-site personnel, instructing them to troubleshoot and fix the device indicated in the message. A signal may also be sent to device 312 in order to remedy the issue, if possible, and/or place device 312 in safe mode.

Process 600 then terminates at step 609.

Referring now to FIG. 7, a flowchart illustrating an exemplary process 700 for delivering and displaying themes on deployed devices 312, according to an aspect of the present disclosure, is shown.

Theme changes may be scheduled, delivered and applied. Themes may be deployed in advance and activated according to timing and duration rules contained therein or pushed to the desired devices 312 and immediately applied. Theme bundles may include background images, button images, video files, audio files, and the like. Themes may be displayed until they expire, the original theme is restored or another theme is applied.

Process 700, which may execute within system 10 and display a theme having a beginning and end time, begins at step 701 with control passing immediately to step 703.

At step 703, the theme is received at one of many devices 312 which will display the theme.

At step 705, device 312 verifies the integrity of the received theme.

At step 707, device 312 applies the verified theme at the designated start time.

At step 709, after displaying the theme for the indicated time, device 312 restores the default theme.

Process 700 then terminates at step 711.

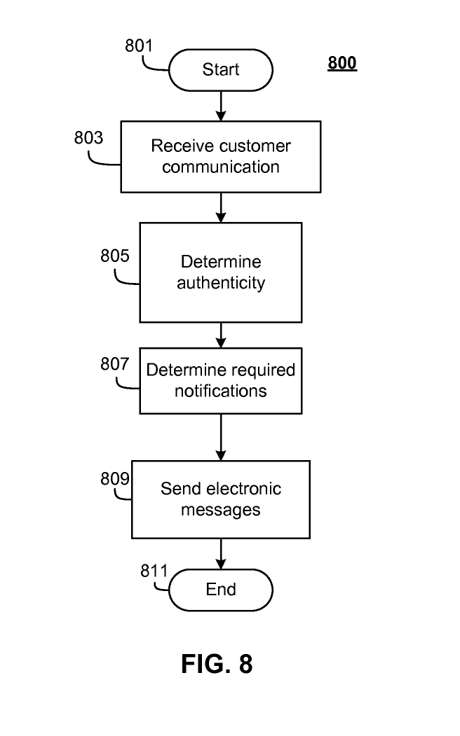

Referring now to FIG. 8, a flowchart illustrating an exemplary process 800 for receiving feedback from customers and delivering actionable electronic messages, according to an aspect of the present disclosure, is shown.

Upon receipt of an electronic message or messages, or via historical analysis of a customer rating or answer, an electronic message or messages may be generated by system 10 communicating necessary and/or recommended actions for various Business employees. In some aspects, a customer rating is analyzed to determine if it is authentic, rather than a prank or false rating. For example, people may submit false, funny, or satirical ratings and comments which need not be replied to. In some aspects, different employees of a Business will desire different thresholds for notification, e.g., a Store Manager may wish to be notified of every Terrible rating, but a District Manager may only wish to be notified if a store receives a certain number of negative ratings within a defined time period, or if all of the stores in the District receive a certain number of negative ratings within a defined time period.

Process 800, which may execute within system 10 and send electronic messages in response to a genuine customer rating or answer, begins at step 801 with control passing immediately to step 803.

At step 803, a customer communication or rating is received. This communication may be positive or negative.

At step 805, the authenticity of the communication is determined. It the communication is authentic, step 807 executes.

At step 807, the communication is incremented to all other such communications and compared to all relevant notification thresholds, with a determination being made of all required notifications.

At step 809, one or more electronic messages is generated and sent to the appropriate individuals in accordance with the required notifications determined by step 806.

Process 800 then terminates at step 811.

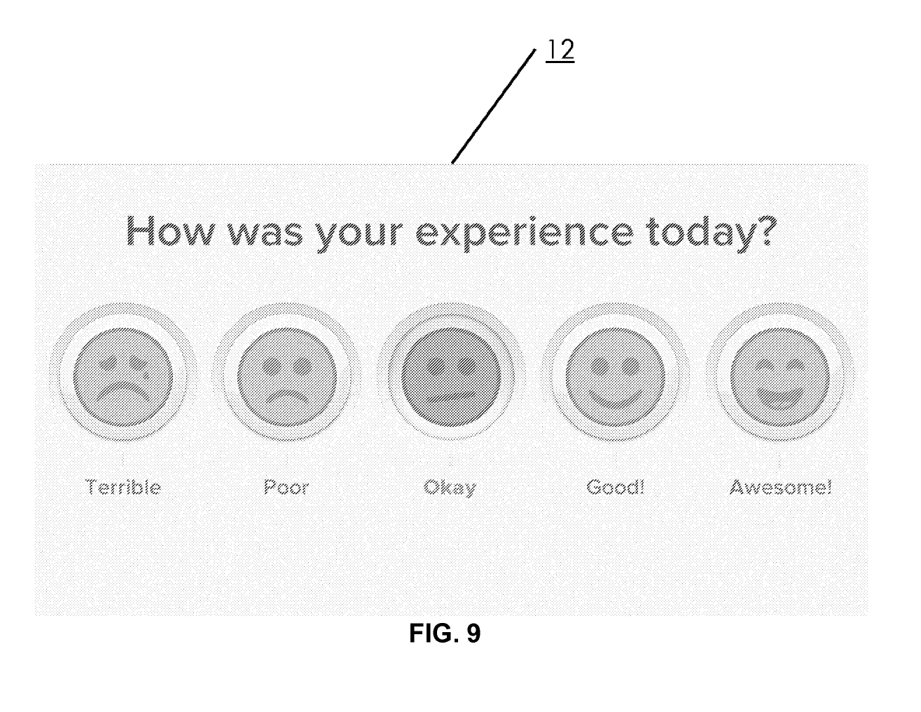

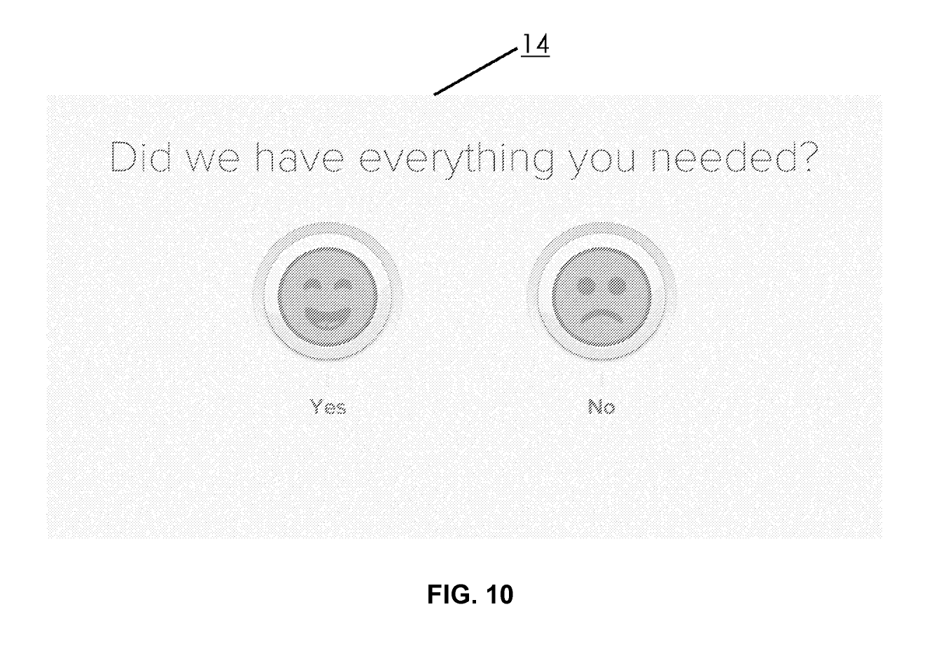

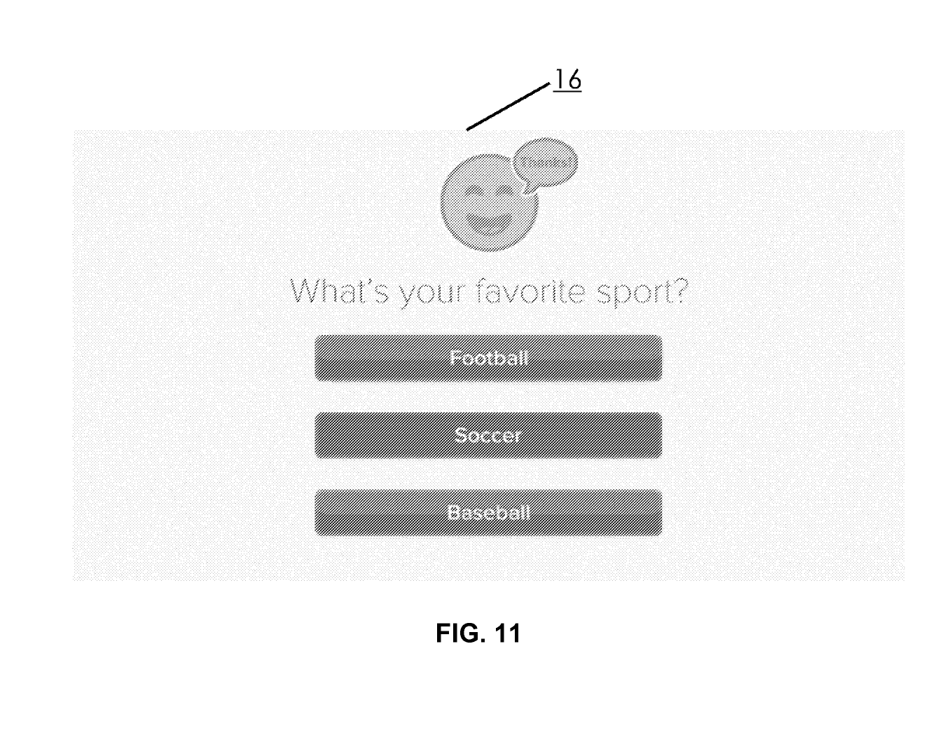

Turning now to FIGS. 9-12, it is assumed that the Business has selected an Emoticon-type Interface for receiving inputs from customers. In the example of FIG. 9, a screen 12 of simple Emoticon faces permit the customer to select the Emoticon which best represents his or her experience at the location of the Business. The Emoticon 14 shown in FIG. 10 inquires as to whether the Business provided all that was required for the customer that day. Other questions can also be asked as shown at FIG. 11. The system can also provide for the customer to add a comment, or seek the real-time assistance of a manager shown by screen 16 of FIG. 12.

After screen 16 is displayed, a screen comprising a QR code, web URL, or other prompt can be presented. In an aspect, the QR code, web URL, or other prompt is integrated into screen 18. The QR code, web URL, or other prompt can be utilized by a customer to access a centrally programmable customer engagement website via a customer computing device (e.g., a smartphone, a tablet computing device, a laptop). The customer may access the website within the store of the Business or choose to access the website at another location (e.g., the customer's home). The customer may interact with the website by, for example, leaving feedback, assigning the feedback to the Business by geo-location or another means, or the like.

In another aspect, the customer may, from the customer computing device interact with system 10, utilizing the customer computing device to provide feedback, receive screens, and the like.

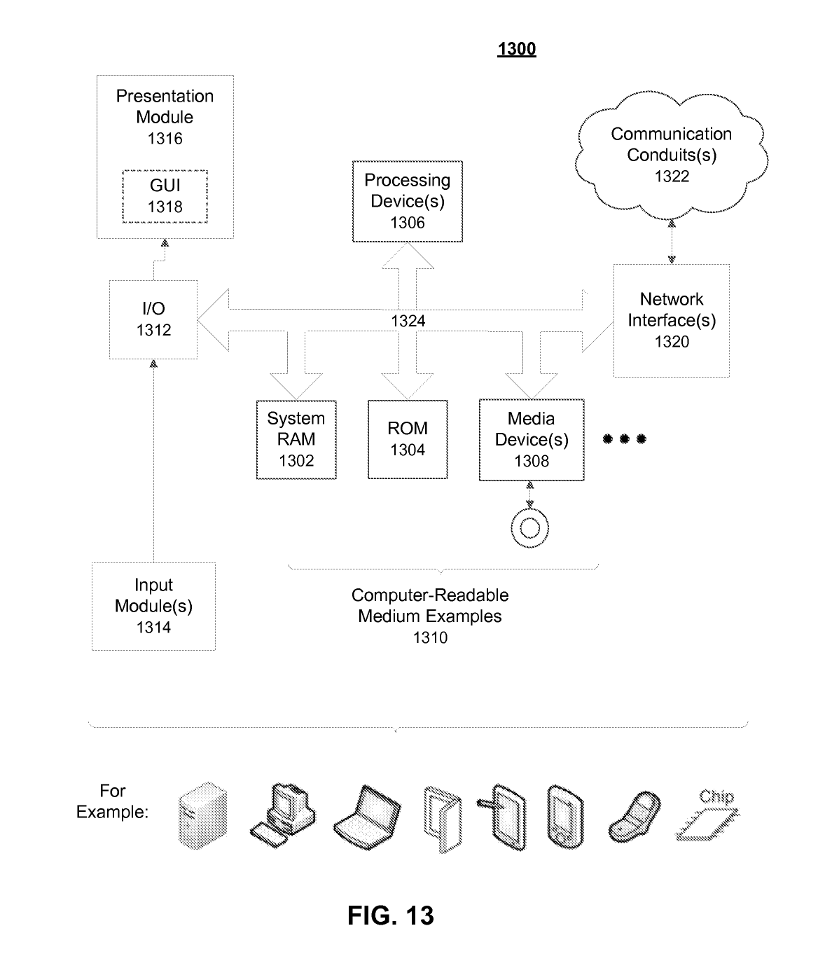

Referring now to FIG. 13, a block diagram of an exemplary computer system useful for implementing various aspects the processes disclosed herein, in accordance with one or more aspects of the present disclosure, is shown.

Computing functionality 1300 may comprise volatile and non-volatile memory, such as RAM 1302 and ROM 1304, as well as one or more processing devices 1306 (e.g., one or more central processing units (CPUs), one or more graphical processing units (GPUs), and the like). Computing functionality 1300 also optionally comprises various media devices 1308, such as a hard disk module, an optical disk module, and so forth. Computing functionality 1300 may perform various operations identified above when the processing device(s) 1306 executes instructions that are maintained by memory (e.g., RAM 1302, ROM 1304, and the like).

More generally, instructions and other information may be stored on any computer readable medium 1310, including, but not limited to, static memory storage devices, magnetic storage devices, and optical storage devices. The term “computer readable medium” also encompasses plural storage devices. In all cases, computer readable medium 1310 represents some form of physical and tangible entity. By way of example, and not limitation, computer readable medium 1310 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 1302, ROM 1304, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 1300 may also comprise an input/output module 1312 for receiving various inputs (via input modules 1314), and for providing various outputs (via one or more output modules). One particular output mechanism may be a presentation module 1316 and an associated GUI 1318. Computing functionality 1300 may also include one or more network interfaces 1320 for exchanging data with other devices via one or more communication conduits 1322. In some aspects, one or more communication buses 1324 communicatively couple the above-described components together.

Communication conduit(s) 1322 may be implemented in any manner (e.g., by a local area network, a wide area network (e.g., the Internet), and the like, or any combination thereof). Communication conduit(s) 1322 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 9. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

Referring now to FIG. 14, a block diagram of an exemplary system for facilitating user engagement according to an aspect of the present disclosure, is shown.

Cloud-based, Internet-enabled device communication system 100 includes a plurality of users 102 (shown as users 102a-g in FIG. 10) accessing—via a computing device 312 (shown as respective computing devices 312-g in FIG. 10) and a network 106, such as the global, public Internet—an application service provider's cloud-based, Internet-enabled infrastructure 101.

In various aspects, computing device 312 may be configured as: a desktop computer 312a; a laptop computer 312b; a tablet or mobile computer 312c; a smartphone (alternatively referred to as a mobile device) 312d; a Personal Digital Assistant (PDA) 312e; a mobile phone 312f; a television (e.g., a television equipped with network connectivity and VOD applications, a television connected to a DVR service or apparatus) 312g; any commercially-available intelligent communications device; or the like.

An application service provider's cloud-based, communications infrastructure 101 may include one or more online administrative portals 104, one or more application servers 108, and a content database 105. In various aspects, content database 105 is not contained within infrastructure 101. Infrastructure 101 may access analytics engine 107. Infrastructure 101 may further include communications gateways such as an email gateway, an instant messaging gateway and the like.

Content database 105 is configured to store content such as content streamed or otherwise presented to user 102. In an aspect, content database 105 contains a set of pre-programmed questions which can be selected for presentation to users 102.

In some aspects, system 100 comprises analytics engine 107. Analytics engine 107 may contain logic to analyze the user input and permit the Business to view analyzed user information derived from user input. Analytics engine 107 may be accessed by infrastructure 101 in order to permit the business to change the Business-defined analysis parameters.

As will also be appreciated by those skilled in the relevant art(s), in an aspect, various content would be generated by online administrative portal 104 in response to input from users or the Business over Internet 106. That is, in such an aspect, online administrative portal 104 is a typical web server running a server application at a website which sends out webpages in response to Hypertext Transfer Protocol (HTTP) or Hypertext Transfer Protocol Secured (HTTPS) requests from remote browsers on various computing devices 312 being used by various users 102. Thus, server 104 is able to provide a graphical user interface (GUI) to users 102 of system 100 in the form of, for example, webpages. These webpages are sent to the user's PC, laptop, mobile device, PDA, television, tablet or like device 312, and would result in the GUI being displayed.

As will be appreciated by those skilled in the relevant art(s) after reading the description herein, alternate aspects of the present disclosure may include providing a tool for facilitating content sharing coupled with a producer-designated physical asset to devices 312 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all personnel/employees of the same company, the present disclosure may be implemented as a stand-alone system, rather than as a web service (i.e., Application Service Provider (ASP) model utilized by various unassociated/unaffiliated users) as shown in FIG. 10.

As will also be appreciated by those skilled in the relevant art(s) after reading the description herein, alternate aspects of the present disclosure may include providing the tools for facilitating content sharing coupled with a producer-designated physical asset via infrastructure 101 and devices 312 via a browser or operating system pre-installed with an application or a browser or operating system with a separately downloaded application on such devices 312. That is, as will also be apparent to one skilled in the relevant art(s) after reading the description herein, the application that facilitates the content sharing platform herein, may be part of the “standard” browser or operating system that ships with computing device 312 or may be later added to an existing browser or operating system as part of an “add-on,” “plug-in,” or “app store download.”

It will thus be appreciated by those skilled in the art that the system and method of the present invention facilitates real-time customer and employee engagement with the Business through Managed Devices and includes the following features:

(1) The programming and management of electronic devices in Managed Device Groups with interactive content designed to capture a depth and breadth of customer insights and feedback;

(2) The ability to process and analyze large volumes of data in an iterative, evolutionary manner so as to continually enhance reporting relevance; and

(3) The ability to facilitate location and issue-based connectivity channels between a business and its customers for, for example, first issue resolution.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein, implemented outside of a social network, implemented as a standalone customer satisfaction platform). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer implemented method for facilitating user engagement with a Business via a plurality of connected electronic devices, the method comprising the steps of:
(a) remotely displaying a first content on at least one of the plurality of electronic devices;
(b) receiving, via the at least one of the plurality of electronic devices, a first user input, the first user input being related to the first content displayed on the at least one of the plurality of electronic devices;
(c) providing the first user input to a system server;
(d) analyzing the first user input via the system server, wherein the analyzing is at least in part performed using Business-defined parameters, creating analyzed user input; and
(e) providing the analyzed user input to the Business;
wherein the analyzed user input is provided to the Business in approximately real-time.

2. The method of claim 1, wherein the remote displaying step (a) comprises the steps of:
(i) accessing an online administrative portal;
(ii) creating at least one Managed Device Group using the online administrative portal, where each of the at least one Managed Device Groups contains at least one electronic device of the plurality of electronic devices, and the at least one Managed Device Group designates different aspects of the Business;
(iii) creating system rules for each Managed Device Group, the creating comprising the steps of:
(a) selecting a content amount indicating the number of content to be pulled from a Business content list and displayed, creating a series;
(b) selecting content ordering rules for the content series; and
(c) where applicable, selecting at least one feature to be included within each series; and
(iv) providing content to each Managed Device Group using the online administrative portal, comprising the steps of:
(a) selecting an interface type;
(b) drafting content for the interface type;
(c) classifying the drafted content by functional reporting area;
(d) assigning the content to one or more Managed Device Groups;
(e) assigning the content to one or more Business locations; and
(f) publishing the content on the devices in each Managed Device Group.

3. The method of claim 2, wherein the drafted content of step (iv)(b) is drafted in multiple languages including a primary and at least one optional language.

4. The method of claim 2, wherein content is displayed to a plurality of users including a first user and a second user of one of the plurality of electronic devices and at least some of the content displayed to the first user is different than the content displayed to the second user.

5. The method of claim 1, wherein the first content includes a question and a plurality of answers and displaying step (a) comprises the additional step of:
(i) defining, via the system server, a plurality of answer options to the question via selecting from a stored answer list.

6. The method of claim 5, where defining step (a)(i) is based on a geographical location of the at least one of the plurality of electronic devices.

7. The method of claim 5, wherein defining step (a)(i) is executed via machine learning.

8. The method of claim 1, wherein the content is published in real-time.

9. The method of claim 1, wherein a user is one of: a customer; and an employee.

10. The method of claim 1, wherein the first content is at least one question related to the Business.

11. The method of claim 1, wherein the first content is at least one question related to market research.

12. The method of claim 1, wherein the first user input is one of: a selection of a pre-programmed answer appearing on the electronic device; and a response input on the electronic device by the user.

13. The method of claim 1, further comprising the steps of:
(f) generating, via the system server, relevance information related to the analyzed user input; and
(g) updating the Business-defined parameters on the system server in response to the relevance information.

14. The method of claim 1, further comprising the steps of:
(e) remotely displaying a second content on the at least one of the plurality of electronic devices;
(f) receiving, via the at least one of the plurality of electronic devices, a second user input, the second user input being related to the second content displayed on the at least one of the plurality of electronic devices; and
(g) providing the second user input to the system server for analysis.

15. The method of claim 14, wherein steps (a)-(c) and (e)-(g) are executed on the plurality of electronic device for a plurality of users, analyzing step (d) comprising:
(i) determining, via analysis of the received first user input for the plurality of users, an hourly trend; and
(ii) analyzing the hourly trend based on the received second user input and, where applicable, at least one of: foot traffic data; and
transaction data.

16. The method of claim 14, wherein at least one of the first content and the second content is chosen based on one of: a predefined content order; an external factor; purchasing information; foot traffic data; and historical customer data.

17. The method of claim 14, wherein at least one of the first content and the second content are chosen based on a content order modified by the central server and pushed to the electronic device based on historical analyzed user input.

18. The method of claim 17, wherein step (c) further comprises:
(i) pushing in approximately real-time to the at least one electronic device from the central server, the modified content order;
wherein the modified content order is created by the central server based on the analyzed user input.

19. The method of claim 1, wherein at least one of the first content and the second content are chosen based on a content order modified by the central server and pushed to the electronic device based on a plurality of user responses received by the plurality of electronic devices.

20. The method of claim 1, further comprising the steps of:
(h) sending at least one message from a user to the Business;
(i) sending at least one response from the Business to the user, the response related to the message sent from the user to the Business; and
(j) sending at least one communication generated by the central server to a Business employee at the location where the user message was initiated, the at least one communication related to the message sent from the user to the Business.

21. The method of claim 2, wherein there is more than one Managed Device Group, the electronic devices in one Managed Device Group being positioned at a different location in the Business than the electronic devices in another Managed Device Group.

22. The method of claim 2, wherein the one or more Business locations are organized into a plurality of districts and tiers, the content assignable by at least one of: reporting tier; individual selection; selection of a designated location profile; and selection of a tagged location profile.

23. The method of claim 2, wherein each of the plurality of connected electronic devices displays a default theme comprising a plurality of graphical elements and animations pushed from the system server, further comprising the steps of:
(g) receiving, from the system server at each of the plurality of electronic devices within one of the at least one Managed Device Groups, a theme comprising a second plurality of graphical elements and animations and a display time; and
(h) displaying the theme for the display time.

24. The method of claim 2, step (iv) further comprising the step of:
(g) selecting the frequency the specific content will be displayed on each Managed Device Group and the one or more Business locations.

25. A system for facilitating user engagement, the system comprising:
(a) a core server having a processor and connected to a data storage for administration of one or more Managed Device Groups, a processor of the core server is configured to:
(i) display content on a plurality of electronic devices;
(ii) receive, via the plurality of electronic devices, user inputs, the user inputs being related to the content displayed on the electronic device;
(iii) provide the user input to a system server;
(iv) analyze the user input via the system server, wherein the input is analyzed at least in part using Business-defined parameters to create analyzed user input; and
(v) provide the analyzed user input to the Business and alter the Business-defined parameters based on the user input.

26. The system of claim 25, wherein the processor of the core server is further configured to:
(vi) access an online administrative portal;
(vii) receive a request to create one or more Managed Device Groups using the online administrative portal, where the Managed Device Groups contain single electronic devices or groups of electronic devices, and the Managed Device Groups designate different aspects of the Business;
(viii) create system rules for each Managed Device Group, comprising receiving:
(a) selection of a content amount indicating the number of content to be pulled from a Business content list and displayed, creating a series;
(b) selection of content ordering rules for the content series; and
(c) selection of at least one feature to be included within each series; and
(ix) receive a request to provide content for each Managed Device Group using the online administrative portal, comprising requests to:
(a) select an interface type;
(b) draft content for a given interface type;
(c) classify the drafted content by functional reporting area;
(d) assign the content to one or more Managed Device Groups;
(e) assign the content to one or more Business locations; and
(f) publish content on the devices in each Managed Device Group.

27. The system of claim 25, wherein a user is one of: a customer; and an employee.

28. The system of claim 26, wherein there is more than one Managed Device Group, the electronic devices in one Managed Device Group being positioned at a different location in the Business than the electronic devices in another Managed Device Group.

29. The system of claim 28, wherein the one or more Business locations are organized into a plurality of districts and tiers, the content assignable by at least one of: reporting tier; individual selection; selection of a designated user profile;
and selection of a tagged location profile.

30. The system of claim 26, wherein the processor of the core server is further configured to:
send at least one message from a user to the Business;
send at least one response from the Business to the user, the response related to the message sent from the user to the Business.

31. One or more computer storage media having stored thereon multiple instructions that facilitate user engagement by, when executed by one or more processors of a computing device, causing the one or more processors to:
(a) display a first content on at least one of the plurality of electronic devices;
(b) receive, via the at least one of the plurality of electronic devices, a first user input, the first user input being related to the first content displayed on the at least one of the plurality of electronic devices;
(c) provide the first user input to a system server;
(d) analyze the first user input via the system server, wherein the analyzing is at least in part performed using Business-defined parameters, creating analyzed user input; and
(e) provide the analyzed user input to the Business;
wherein the analyzed user input is provided to the Business in approximately real-time.

32. One or more computer storage media as recited in claim 31, wherein the multiple instructions further cause one or more processors to access an online administrative portal to;
(f) receive a request to create one or more Managed Device Groups using the online administrative portal, where the Managed Device Groups contain single electronic devices or groups of electronic devices, and the Managed Device Groups designate different aspects of the Business;
(g) create system rules for each Managed Device Group, comprising receiving:
(i) selection of a content amount indicating the number of content to be pulled from a Business content list and displayed, creating a series;
(ii) selection of content ordering rules for the content series; and
(iii) selection at least one feature to be included within each series; and
(h) receive a request to provide content for each Managed Device Group using the online administrative portal, said request to create content comprising requests to:
(i) select an interface type;
(ii) draft content for a given interface type;
(iii) classify the drafted content by functional reporting area;
(iv) assign the content to one or more Managed Device Groups;
(v) select the content to one or more Business locations; and
(vi) publish the content on the devices in each Managed Device Group;.

33. One or more computer storage media as recited in claim 31, wherein there are more than one Managed Device Groups, the electronic devices in one Managed Device Group being positioned at a different location in the Business than the electronic devices in another Managed Device Group.

34. The system of claim 31, wherein the one or more Business locations are organized into a plurality of districts and tiers, the content assignable by at least one of: reporting tier; individual selection; selection of a designated user profile;
and selection of a tagged location profile.

35. One or more computer storage media as recited in claim 31, wherein the multiple instructions further cause one or more processors to:
(h) send at least one message from a user to the Business;
(i) send at least one response from the Business to the user, the response related to the message sent from the user to the Business; and
(j) send at least one communication generated by the central server to a Business employee, the at least one communication related to the message sent from the user to the Business.
